(19) United States
(12) Patent Application Publication
(10) Pub. No.: US 2007/0114743 A1
(43) Pub. Date: May 24, 2007

(54) Side motion propelled skateboard device

(76) Inventor: Shane Chen, Camas, WA (US)

Correspondence Address: STEVEN J. ADAMSON, PC, P.O. BOX 5997, PORTLAND, OR, 97228, US

(21) Appl. No.: 11/591,192

(22) Filed: Oct. 31, 2006

Related U.S. Application Data
(60) Provisional application No. 60/760,638, filed on Jan. 21, 2006.
(60) Provisional application No. 60/734,612, filed on Nov. 7, 2005.

(51) Int. Cl. B62M 1/00

(52) U.S. Cl. 280/87.042

(57) ABSTRACT

A skateboard device that achieves forward propulsion from the sideways movement (side-to-side and/or twisting motion) of a user. Various embodiments are disclosed, each including a front and rear wheel assemblies mounted to a board. One or more of the wheel assemblies may have a relatively high axle shaft angle and the axle shaft angles of the two assemblies may be different. The wheel assemblies may have the same orientation or an opposite orientation or be changeable between the two.

### CROSS REFERENCE TO RELATED APPLICATIONS

This application claims the benefit of U.S. Provisional Application No. 60/760,638, filed Jan. 21, 2006, entitled “Side Movement Propelled Wheeled Recreational Device” and having the same inventor as above and U.S. Provisional Application No. 60/734,612, filed Nov. 7, 2005, also entitled “Side Movement Propelled Wheeled Recreational Device” and has the same inventor as above.

### FIELD OF THE INVENTION

The present invention relates to skateboards and like devices and, more specifically, to skateboard devices that are conducive to achieving forward propulsion from side-to-side movement of a user.

### BACKGROUND OF THE INVENTION

Conventional skateboards and variations thereof have long been known in the art. A conventional skateboard typically includes a board and front and rear wheel assemblies. Each of the wheel assemblies preferably includes a pair of wheels, an axle, an axle pivot shaft or related structure and a grommet or the like for cushioning and biasing the axle towards a neutral position.

The front wheel assembly is oriented in a direction opposite that of the rear wheel assembly. One reason for the opposite orientation is to enhance turning. When a user leans to one side the front wheels are turned in a first direction while the rear wheels are turned in the opposite direction, thereby decreasing the radius of the turn.

The angle of the axle pivot shaft or related structure is typically low, at, for example, approximately 30 degrees and may range from approximately 20-35 degrees. Axle shaft angles in this range provide suitable turning in the conventional opposite orientation and there is no need to consider larger angles. Larger angles may make the board turn too sharply making it disadvantageously difficult to ride.

It should also be recognized that in conventional skateboards the axle shaft angle is the same in both wheel assemblies. An angle differential is not needed because their opposite wheel assembly orientation provides adequate turning and propulsion is from pushing off with a user's foot and not other means.

Applicant has recognized in the present invention that to propel a skateboard forward by side-to-side (or twisting) movement of a user, it may be desirable to have an axle shaft angle that is greater than that utilized in conventional skateboards. Since prior art skateboards are not primarily concerned with achieving forward propulsion from side to side or twisting movement, they do not possess a higher axle shaft angle. Applicant, in investigating the prior art for a high axle shaft angle skateboard was able to find one “long board” skateboard, a board of greater than conventional length and designed to approximate the “surfing” experience in use, with an axle shaft angle of approximately 42 degrees. Long boards, like conventional skateboards, are designed to be propelled primarily by a user pushing-off the ground with one foot.

To enhance the use and enjoyment of skateboards and like devices and to facilitate their adoption as an alternative recreation and/or transportation means, there is a need for a board that is conducive to other methods of propulsion. One manner within the present invention is the use of side-to-side movement (from the line of direction of travel, front to back for a user standing sideways on the board) or twisting movement to propel the board forward. Attributes of such a wheeled board may include: configuring the wheel assemblies (particularly the front wheel assembly) to have a relatively higher axle shaft angle, configuring the wheel assemblies to have different axle shaft angles, orienting the wheel assemblies in the same direction, and/or configuring the skateboard to be bi-partite or to include a changeable orientation wheel assembly structure, either of which permit a user to change the orientation of the wheel assemblies, if so desired. Accordingly, there is a need for a board with these and related attributes.

### SUMMARY OF THE INVENTION

Accordingly, it is an object of the present invention to overcome the shortcomings of the prior art.

It is another object of the present invention to provide a skateboard device that is readily propelled forward by side motion (side-to-side and/or twisting movement) of a user.

It is also an object of the present invention to provide a skateboard device that provides ready forward propulsion without a user having to repeatedly push off the ground with their foot.

These and related objects of the present invention are achieved by use of a side motion propelled skateboard device as described herein.

In one embodiment, the present invention may include a skateboard device in which the front wheel assembly has a front axle angle, measured from horizontal, that is approximately 50 degrees or more.

In another embodiment, the present invention may include a skateboard device having a front wheel assembly and a rear wheel assembly in which the front axle angle is different from the rear axle angle.

In another embodiment, the present invention may include a skateboard device having a front wheel assembly and a rear wheel assembly that are oriented in the same direction.

In yet another embodiment, the present invention may include a skateboard device having a front wheel assembly and a rear wheel assembly in which the orientation of one of the front and rear wheel assemblies is changeable from a same direction orientation to an opposite direction orientation and vice versa.

The attainment of the foregoing and related advantages and features of the invention should be more readily apparent to those skilled in the art, after review of the following more detailed description of the invention taken together with the drawings.

### BRIEF DESCRIPTION OF THE DRAWINGS

FIG. 1 illustrates a first embodiment of a skateboard configured to achieve forward propulsion from side movement of a user in accordance with the present invention.

FIGS. 2-9 illustrate other embodiments of a skateboard configured to achieve forward propulsion from side movement of a user in accordance with the present invention.

### DETAILED DESCRIPTION

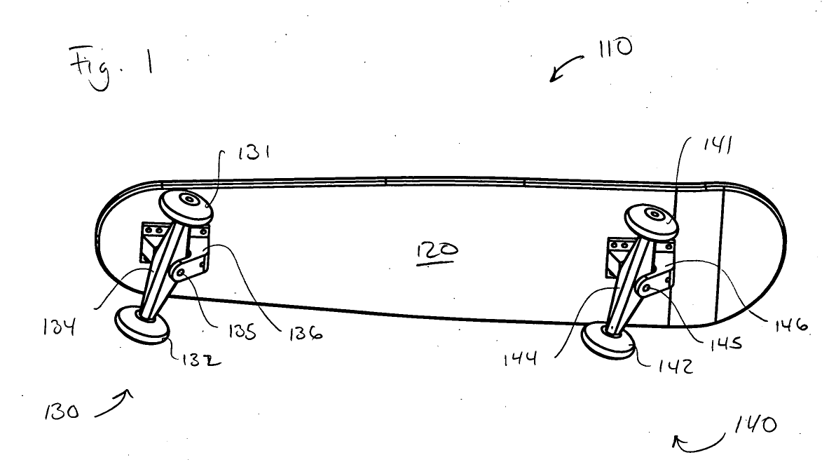

Referring to FIG. 1, a first embodiment of a skateboard device 110 configured to achieve forward propulsion from side-to-side movement of a user in accordance with the present invention is shown. Skateboard 110 may include a board 120 from which descend a front wheel and a rear wheel assembly 130,140. Each of the wheel assemblies may include a pair of wheels 131,132,141,142 which are coupled via axle 134,144. The axle preferably rotates about axle shaft 135,145 which in turn is held in place by mounting body 136,146. Various mounting body configurations or other means for holding an axle shaft or otherwise causing an axle to rotate as though it where rotating about an axle shaft disposed at a given angle from board 120 may be used.

In the embodiment of FIG. 1, the front wheel assembly or “truck” 130 is preferably configured such that the axle shaft 130 is preferably disposed at an axle angle of approximately 50 degrees or more from horizontal and more preferably of approximately 60 degrees or more from horizontal. The term axle angle as used herein is intended to mean the smallest of the two angle measurements from horizontal. For example, an axle angle of 60 degrees has a complementary angle of 120 degrees. The term axle angle is intended to be the smaller (most direct measure) of the angle, e.g., 60 degrees in the present example.

By increasing this angle above that of conventional skateboards, skateboard 110 and others herein are capable of achieving greater forward propulsion from side-to-side movement of the skateboard by a user.

The embodiment of FIG. 1 is also unique because the front and rear wheel assemblies have the same orientation. In conventional skateboards, the wheel assemblies face opposite one another, an arrangement that facilitates turning. In the present invention, the wheel assemblies may have the same or opposite orientation (opposite discussed below).

In the embodiment of FIG. 1, the angle of front axle shaft 135 is preferably greater than that of rear axle shaft 145. In this arrangement, the front wheel assembly turns with a sharper radius than the rear wheel assembly causing the front of the board to effectively turn about the rear wheel assembly which thereby achieves a turning of the board.

The angle of the rear axle shaft may be the same as that of the front angle and this indeed works well when generating forward propulsion from side movement, but it forms a board that is hard to turn. By making the rear axle angle less than the front axle angle, in a same orientation board, turning is enhanced.

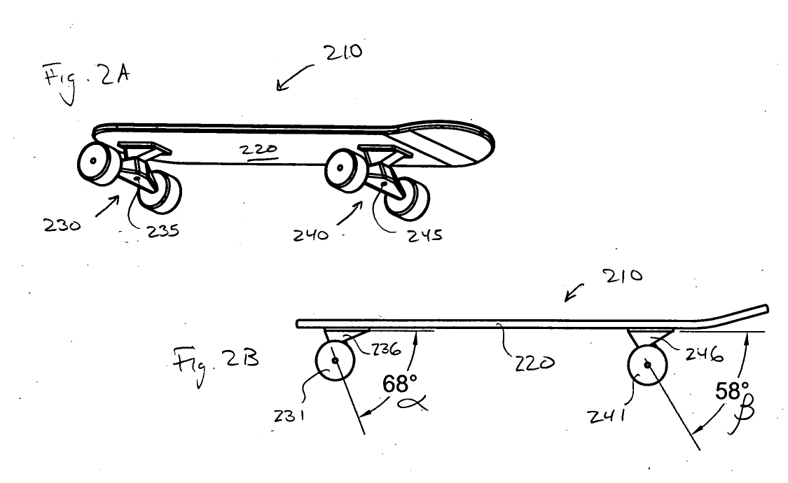

FIGS. 2A-2B illustrate board 210 with a front axle shaft angle, α, at 68 degrees and a rear axle shaft angle, β, of 58 degrees (both from horizontal, indicated by the bottom of the board). While 68 and 58 degrees are representative examples, it should be noted that the front wheel assembly has an axle shaft disposed at approximately 5-85 degrees and more preferably 25-80 degrees and even 45-75 degrees. The rear axle angle is preferably approximately 5 to 10 degrees or more less than that of the front axle angle to facilitate a desired “turnability” of the skate board. Turning may also be achieved by a user leaning on the back end of the board until the front end rises and then placing the front end back down in the desired direction.

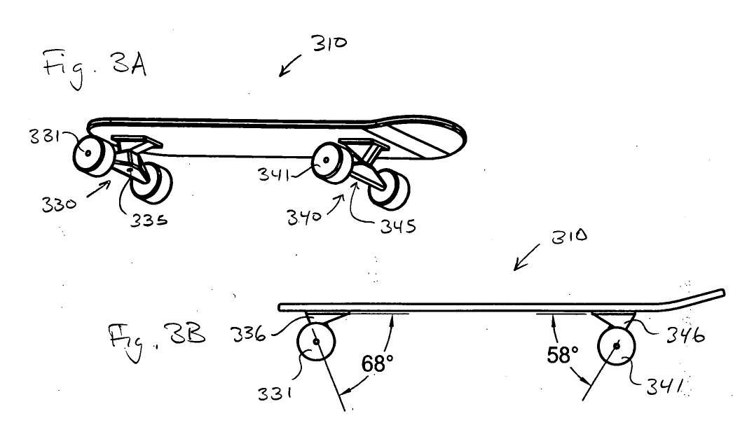

Referring to FIGS. 3A-3B, a perspective bottom view and a side elevation view of another embodiment of a skateboard 310 in accordance with the present invention is shown. Skateboard 310 may include a board 320, a front wheel assembly 330 having a pair of wheels 331,332 coupled through axle 334, and a rear wheel assembly 340 having a pair of wheels 341,342 coupled through axle 344. These components may be configured substantially as discussed above with reference to boards 110,210 of FIGS. 1 and 2A-2B.

A difference in skateboard 310 of FIGS. 3A-3B is that the wheel assemblies are oriented opposite one another. This opposite arrangement is the arrangement found in conventional skateboards. In the present invention, the axle shaft angle is larger to accommodate side-to-side or twisting movement based forward propulsion. The angles α and β are preferably as discussed above for skateboard 110,210 of FIGS. 1 and 2.

In a conventional or opposite orientation, forward propulsion may be achieved with a twisting movement of a user. Due to opposite orientation, the board turns readily (the front and rear axle angles need not be different to accommodate turning). However, since users tend to stand towards the back of the board, a disproportionate amount of drive force is applied towards the rear assembly. By making the rear axle angle less, the amount of driving force attributable to each wheel assembly is better balanced across the board leading to more even and efficient forward propulsion.

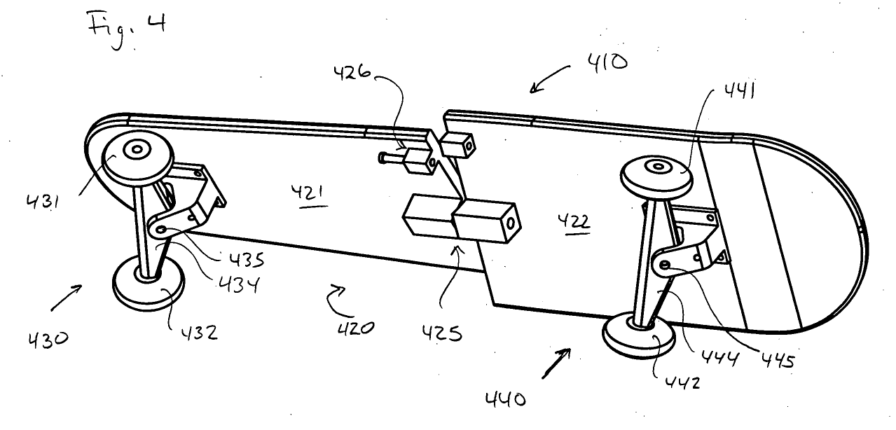

Referring to FIG. 4, a bottom perspective view of another embodiment of a skateboard 410 configured to achieve forward propulsion from side-to-side movement of a user in accordance with the present invention is shown. Skateboard 410 may include a board 420, a front wheel assembly 430 having a pair of wheels 431,432 coupled through axle 434, and a rear wheel assembly 440 having a pair of wheels 441,442 coupled through axle 444. The skateboard 410 of FIG. 4 may be configured in a manner very similar to skateboard 110,210 discussed above, yet skateboard 410 preferably includes a bi-partite board having a front part 421 and a rear part 422.

The two parts of board 420 are preferably joined about a longitudinally disposed pivot shaft 425 or another suitably arranged and configured moveable joining structure. A locking pin 426 or other suitable releasable locking mechanism is preferably provided so that a user may choose to use board 420 as a single piece board (such as board 120,220,320) or as a two-part board.

When used as a two-part board, the user may achieve quicker turning by moving the wheel assemblies in two different directions that work collaboratively to reduce the turning radius.

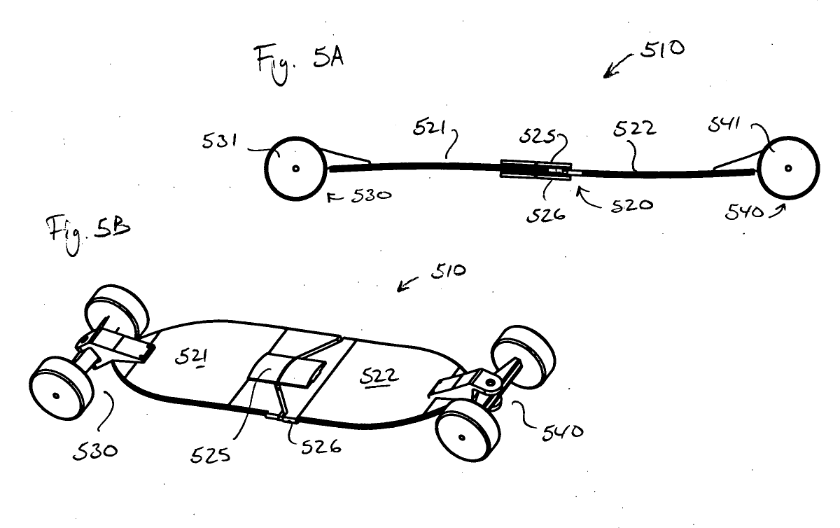

Referring to FIGS. 5A-5B, a side elevation and a top perspective view of another embodiment of a skateboard 510 in accordance with the present invention is shown. Skateboard 510 may include a board 520, a front wheel assembly 530 having a pair of wheels 531,532 coupled through axle 534, and a rear wheel assembly 540 having a pair of wheels 541,542 coupled through axle 544. The components may be substantially as discussed herein for, like components.

Similar to board 420 of FIG. 4, board 520 of FIG. 5 may be bi-partite. In the board 520 of FIG. 5, the wheel assemblies are mounted at the ends of the board and outside of it. The board 520, board pivot shaft 525 and locking mechanism 526 are such that the two board parts 521,522 may be turned 180 degrees and re-locked. A result of this structure is that the wheel assemblies may be oriented in the same direction (non-conventional) or board part 522 may be flipped to orient the wheel assemblies in opposite directions (conventional).

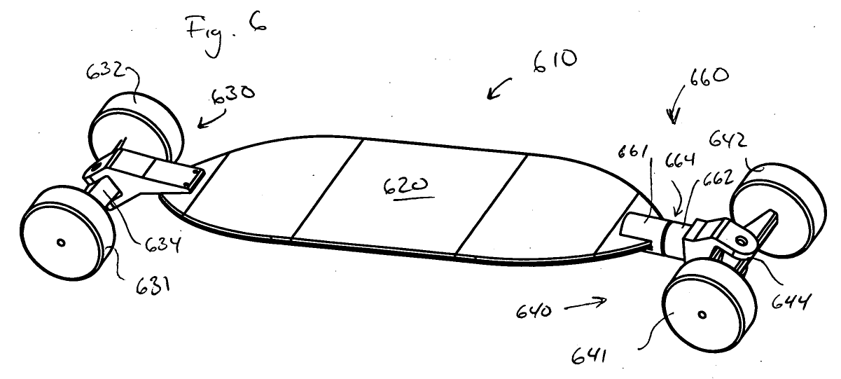

Referring to FIG. 6, a top perspective view of another embodiment of a skateboard 610 in accordance with the present invention is shown. Skateboard 610 may include a board 620, a front wheel assembly 630 having a pair of wheels 631,632 coupled through axle 634, and a rear wheel assembly 640 having a pair of wheels 641,642 coupled through axle 644. The components may be substantially as discussed herein for like components.

In the embodiment of FIG. 6, one of the wheel assemblies, for example, the rear wheel assembly 640 is mounted via a mount shaft mechanism 660 or the like that permits the wheel assembly to be mounted in a conventional manner or flipped to a non-conventional manner.

Mechanism 660 may include a board side mounting member 661 and a wheel assembly mounting member 662. Member 662 may be configured to rotate 180 degrees from member 661 and re-lock or be unplugged, wheel assembly 640 flipped, and lockable plugged back into board mounting member 661. Mount shaft mechanism 660 preferably includes a releasable locking mechanism 664 for releasably securing shaft mounting members 661,662. Various releasable locking mechanisms are known in the art and may be in whole or part internal to the mount shaft mechanism 660 (internal to members 661,662) or surface mounted. In this manner, or another suitable releasable attachment manner, a user may move the wheel assemblies between conventional and non-conventional orientations.

In contrast to board 520 of FIG. 5, board 610 of FIG. 6 has a single piece or uninterrupted board surface which may be desirable to a user, permitting less encumbered foot placement on the board, etc.

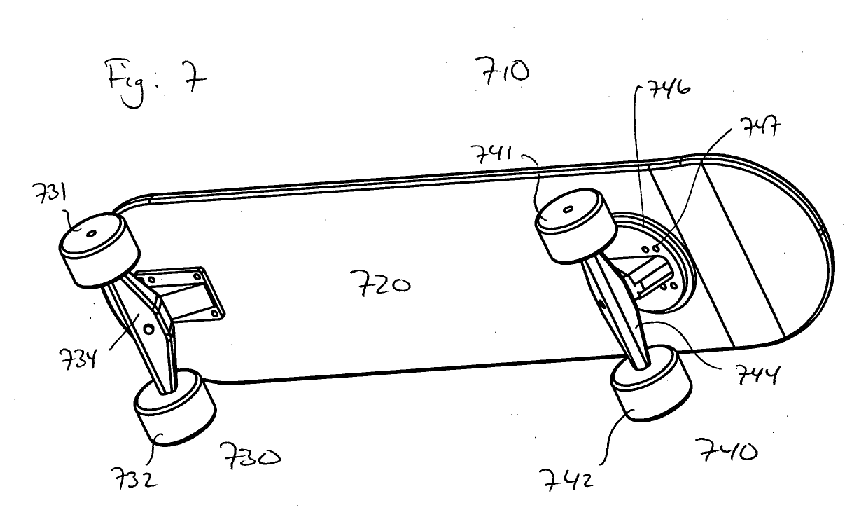

Referring to FIG. 7, a bottom perspective view of another embodiment of a skateboard 710 in accordance with the present invention is shown. Skateboard 710 may include a board 720, a front wheel assembly 730 having a pair of wheels 731,732 coupled through axle 734, and a rear wheel assembly 740 having a pair of wheels 741,742 coupled through axle 744. The components may be substantially as discussed herein for like components.

In FIG. 7, one of the wheel assemblies, for example, the rear wheel assembly 740 is rotatable from a conventional orientation to a non-conventional orientation and vice versa, via rotating disc structure 746. A releasable locking structure 747 permits secure, releasable position of the wheel assembly in a desired position. The rear wheel assembly 740 is rotatable in the horizontal plane to change orientations. Suitable rotatable structures and locking mechanisms are known in the art.

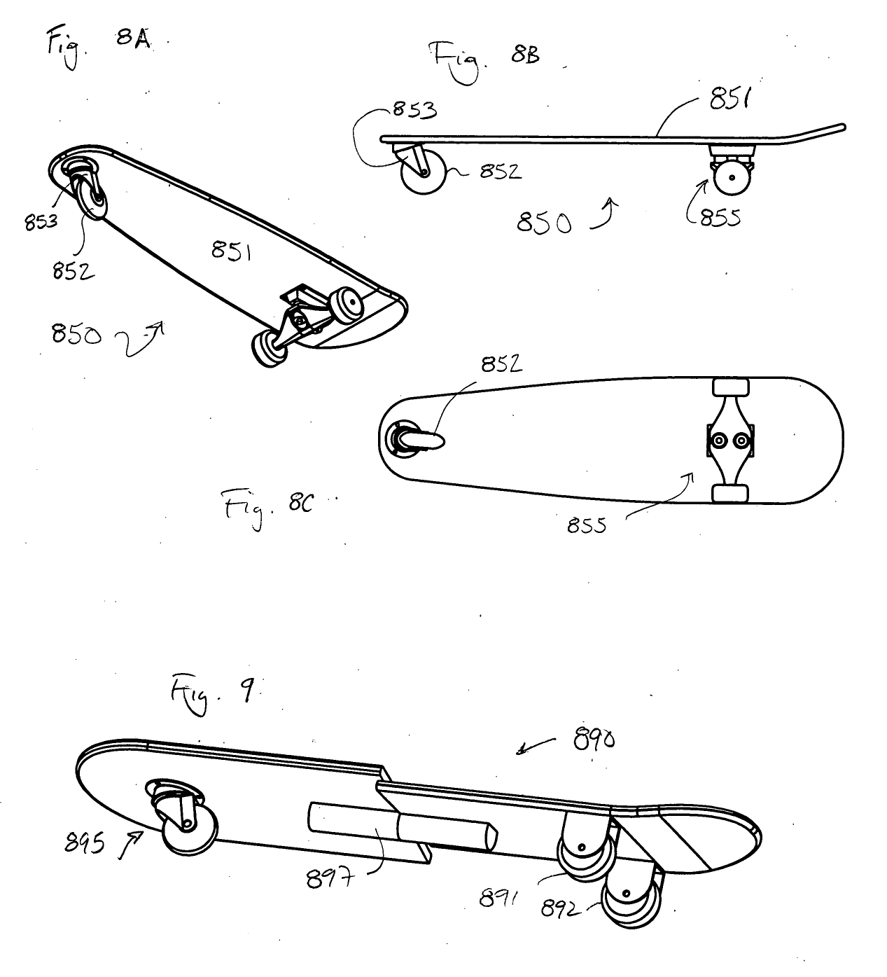

Referring to FIGS. 8A-8C, a bottom perspective, a side elevation and a bottom plan view of another embodiment of a side movement propelled skateboard device 850 in accordance with the present invention are respectively shown. Device 850 may include a platform 851 similar to a conventional skateboard platform. In the illustrated embodiment the platform may taper in width towards the front (in part to accommodate the single front wheel, i.e., enhancing stability by reducing the board width towards those portions supported by a wheel). The front wheel assembly preferably includes a wheel 852 coupled through a biased direction caster 853. The biased direction castor may be biased through a forward tilting arrangement as shown or a spring arrangement of other suitable arrangement. Biased direction casters are known in the art.

Device 850 may be propelled forward by side to side movement of the front end, and hence wheel 852, as a user shifts his or her weight (from side-to-side from the line of direction of the board) over the front end. The rear wheel assembly 855 may be that of a conventional skateboard or as otherwise discussed herein, including having an axle angle of zero degrees.

FIG. 9 illustrates a skate board device 890 in which the rear wheels 891,892 are fixed in position (as opposed, for example, to a turnable axle). The front wheel assembly 895 has a biased direction caster and may be configured as in device 850. A pivoting coupling shaft 897 is used to couple the front end and the back end of the board, similar to skateboards 410,510 of FIGS. 4,5, respectively. Replacing front wheel assembly 895 with a paired wheel arrangement such as assembly 130 of FIG. 1 achieves a skateboard that might function generally as discussed for skateboard 110, 210, 410, etc., described above.

It should be recognized that the rear end of skateboard devices 110,210,310,410,710 and others may terminate with an ascending flap that acts as a plant and pivot place for a the rear foot of a user. The front end in contrast is flat.

While the invention has been described in connection with specific embodiments thereof, it will be understood that it is capable of further modification, and this application is intended to cover any variations, uses, or adaptations of the invention following, in general, the principles of the invention and including such departures from the present disclosure as come within known or customary practice in the art to which the invention pertains and as may be applied to the essential features hereinbefore set forth, and as fall within the scope of the invention and the limits of the appended claims.

1. A skateboard device configured to achieve forward propulsion from the side-to-side movement of a user, comprising:
a board;
a front wheel assembly coupled to the board, the front wheel assembly including first and second wheels coupled through a front axle that is pivotally mounted at a front axle angle;
a rear wheel assembly coupled to the board, the rear wheel assembly including third and fourth wheels coupled through a rear axle that is pivotally mounted at a rear axle angle;
wherein, measured from horizontal, the front axle angle is approximately 50 degrees or more.

2. The device of claim 1, wherein the rear axle angle is different and less than the front axle angle.

3. The device of claim 1, wherein the front axle angle is 5 or more degrees greater than the rear axle angle.

4. The device of claim 1, wherein the front wheel assembly and the rear wheel assembly are oriented in the same direction.

5. The device of claim 1, wherein the front wheel assembly and the rear wheel assembly are oriented in opposite directions.

6. The device of claim 1, wherein the orientation of one of the front and rear wheel assemblies is changeable from a same direction orientation to an opposite direction orientation and vice versa.

7. The device of claim 1, wherein the front axle angle is approximately 60 degrees or more.

8. The device of claim 1, wherein the board includes a front end and a rear end, the front end being substantially flat and the rear end including an ascending portion.

9. A skateboard device configured to achieve forward propulsion from the side-to-side movement of a user, comprising:
a board;
a front wheel assembly coupled to the board, the front wheel assembly including first and second wheels coupled through a front axle that is pivotally mounted at a front axle angle;
a rear wheel assembly coupled to the board, the rear wheel assembly including third and fourth wheels coupled through a rear axle that is pivotally mounted at a rear axle angle;
wherein the front axle angle and the rear axle angle are different.

10. The device of claim 9, wherein the front wheel assembly and the rear wheel assembly have the same orientation.

11. The device of claim 9, wherein the front wheel assembly and the rear wheel assembly have the opposite orientation.

12. The device of claim 9, wherein the orientation of one of the front and rear wheel assemblies is changeable from a same direction orientation to an opposite direction orientation and vice versa.

13. The device of claim 9, wherein the front axle angle ranges from approximately 5-85 degrees.

14. The device of claim 9, wherein the front axle angle ranges from approximately 25-80 degrees.

15. The device of claim 9, wherein the front axle angle is greater than the rear axle angle.

16. The device of claim 9, wherein the board includes a front end and a rear end, the front end being substantially flat and the rear end including an ascending portion.

17. A skateboard device configured to achieve forward propulsion from the side-to-side movement of a user, comprising:
a board;
a front wheel assembly coupled to the board, the front wheel assembly including first and second wheels coupled through a front axle that is pivotally mounted at a front axle angle;
a rear wheel assembly coupled to the board, the rear wheel assembly including third and fourth wheels coupled through a rear axle that is pivotally mounted at a rear axle angle;
wherein the front wheel assembly and the rear wheel assembly have the same orientation.

18. The device of claim 17, wherein the front axle angle ranges from approximately 20-85 degrees.

19. The device of claim 17, wherein the front axle angle ranges from approximately 45-80 degrees.

20. The device of claim 17, wherein the rear axle angle is less than the front axle angle.

21. The device of claim 17, wherein the rear axle angle is 5 or more degrees less than the front axle angle.

22. The device of claim 17, wherein the board includes a front end and a rear end, the front end being substantially flat and the rear end including an ascending portion.

23. A skateboard device configured to achieve forward propulsion from the side-to-side movement of a user, comprising:
a board;
a front wheel assembly coupled to the board, the front wheel assembly including first and second wheels coupled through a front axle that is pivotally mounted at a front axle angle;
a rear wheel assembly coupled to the board, the rear wheel assembly including third and fourth wheels coupled through a rear axle that is pivotally mounted at a rear axle angle;
the orientation of one of the front and rear wheel assemblies is changeable from a same direction orientation to an opposite direction orientation and vice versa.
